(19) United States
(12) Patent Application Publication
(10) Pub. No.: US 2016/0162678 A1
(43) Pub. Date: Jun. 9, 2016

(54) VEHICLE AND METHOD OF CONTROLLING VEHICLE

(71) Applicant: Hyundai Motor Company, Seoul (KR)

(72) Inventor: Hongjun Kim, Gyeonggi-Do (KR)

(21) Appl. No.: 14/854,077

(22) Filed: Sep. 15, 2015

(30) Foreign Application Priority Data
Dec. 8, 2014 (KR) 10-2014-0174877

(51) Int. Cl. G06F 21/36; G06F 3/0484

(52) U.S. Cl. CPC G06F 21/36; G06F 3/04842

(57) ABSTRACT

A vehicle and a method of controlling the vehicle are provided. The vehicle includes an input device that is implemented as at least any of one or more hard keys and a jog shuttle that rotates or is inclined in at least one direction within the vehicle. The input device is configured to receive a command according to a manipulation. In addition, a storage unit is configured to store a combination of commands for the input device as a security pattern. A controller is then configured to perform user authentication based on whether a combination of commands input from the input device matches a security pattern previously stored in the storage unit.

### CROSS-REFERENCE TO RELATED APPLICATION

This application claims the benefit of Korean Patent Application No. 10-2014-0174877, filed on Dec. 8, 2014 in the Korean Intellectual Property Office, the disclosure of which is incorporated herein by reference.

### BACKGROUND

1. Field of Invention

The present invention relates to a vehicle and a method of controlling the vehicle, and more particularly, to performing user authentication based on user manipulation on an input device.

2. Description of the Related Art

A vehicle may perform additional functions for user convenience such as an audio function, a video function, a navigation function, air conditioning control, seat control and lighting control in addition to a default driving function. In such a vehicle, a user may manipulate an input device provided as a mechanical device within the vehicle and input a command for performing the driving function and additional functions of the vehicle. Such an input device is typically disposed in a dashboard, a center fascia, a steering wheel or the like of the vehicle and consists of various physical types such as a hard key or a jog shuttle. Therefore, the user may be provided with the driving function and additional functions at any time.

### SUMMARY

The present invention provides a vehicle for performing user authentication according to a user's manipulation on an input device and a method of controlling the vehicle.

According to an aspect of the present invention, a vehicle, may include: an input device implemented as at least any of one or more hard keys and a jog shuttle that may rotate or be inclined in at least one direction within the vehicle and may be configured to receive a command based on a user's manipulation; a storage unit configured to store a combination of commands for the input device as a security pattern; and a controller configured to perform user authentication based on whether a combination of commands input from the input device matches a security pattern stored in the storage unit in advance.

The vehicle may further include a dashboard; a steering wheel; a center fascia; and a door, wherein the input device may be disposed in at least one of the dashboard, the steering wheel, the center fascia and the door. The storage unit may be configured to store the combination of commands and a sequence thereof as a security pattern, and the controller may be configured to perform user authentication based on whether the combination of commands input by the user and the sequence thereof match the previously stored security pattern.

The vehicle may further include a display unit configured to display a screen for prompting the user to manipulate the input device; an audio video navigation (AVN) device in which at least one application is installed; and a display unit configured to display an output screen of the application installed in the AVN device when the combination of commands input from the input device matches the previously stored security pattern. When the input device receives a predetermined command according to the user's manipulation, the controller may be configured to store a command based on the user's next manipulation as the security pattern in the storage unit.

According to another aspect of the present invention, a vehicle may include: an input device implemented as at least any of one or more hard keys and a jog shuttle that may rotate or be inclined in at least one direction in the vehicle and may be configured to receive a command according to a user's manipulation (e.g., an input manipulation); a communication unit configured to receive a combination of commands for the input device from a server as a security pattern; and a controller configured to perform user authentication based on whether the combination of commands input from the input device matches the security pattern received from the communication unit.

The vehicle may further include a storage unit configured to store the security pattern received by the communication unit. The controller may be configured to read a security pattern stored in the storage unit and perform user authentication based on whether the combination of commands input from the input device matches the previously stored security pattern. The vehicle may further include a dashboard; a steering wheel; a center fascia; and a door. The input device may be disposed in at least one of the dashboard, the steering wheel, the center fascia and the door.

In addition, the vehicle may include a display unit configured to display a screen for prompting the user to manipulate the input device; an audio video navigation (AVN) device in which at least one application is installed; and a display unit configured to display an output screen of the application installed in the AVN device when the combination of commands input from the input device matches the security pattern received from the server. When the input device receives a predetermined command according to the user's manipulation, the communication unit may be configured to transmit a command according to the user's next manipulation to the server as the security pattern.

According to another aspect of the present invention, a method of controlling a vehicle may include receiving a command according to a user's manipulation via an input device implemented as at least any of one or more hard keys and a jog shuttle that may rotate or be inclined in at least one direction in the vehicle; reading a combination of commands for the input device stored in a storage unit in advance; determining whether a combination of commands input from the input device matches the previously stored combination of commands; and performing authentication based on whether the combination of commands input from the input device matches the previously stored combination of commands.

The performing of the authentication may include outputting a user authentication result screen when the combination of commands input from the input device matches the previously stored combination of commands. The performing of the authentication may include outputting a screen for prompting the user to manipulate the input device when the combination of commands input from the input device does not match the previously stored combination of commands.

The method may further include receiving a command for setting a security pattern via the input device; and storing the security pattern input during the receiving of the command for setting the security pattern in the storage unit. The receiving of the command for setting a security pattern may include receiving, by the input device, a predetermined command according to the user's manipulation and receiving a command according to the user's next manipulation as the security pattern. The method may further include, before the reading of the combination of commands, receiving a combination of previously stored commands for the input device; and storing the combination of commands received from the server in the storage unit.

The determining of whether the combination matches the previously stored combination of commands may include determining whether the combination of commands input from the input device and a sequence thereof match the combination of commands that is stored in advance and a sequence thereof. The method may further include, before the receiving of the command according to the user's manipulation, displaying a screen for prompting the user to manipulate the input device.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 illustrates an exemplary exterior of a vehicle according to an exemplary embodiment of the present invention seen from the exterior;

FIG. 2 is an exemplary control block diagram of a vehicle according to an exemplary embodiment of the present invention;

FIG. 3 is an exemplary diagram illustrating an internal configuration of a vehicle according to an exemplary embodiment of the present invention;

FIGS. 4A-4B, 5, and 6 are exemplary diagrams illustrating an exterior of an input device according to various exemplary embodiments of the present invention;

FIG. 7 is an exemplary control flowchart of a vehicle according to an exemplary embodiment of the present invention;

FIG. 8 is a diagram illustrating an exemplary screen displayed on an AVN display before the process enters a security pattern setting mode according to an exemplary embodiment of the present invention;

FIG. 9 is a diagram illustrating an exemplary first security pattern setting screen output from an AVN display according to an exemplary embodiment of the present invention;

FIG. 10 is a diagram illustrating an exemplary second security pattern setting screen output from an AVN display according to an exemplary embodiment of the present invention;

FIG. 11 is an exemplary control flowchart of a vehicle according to another exemplary embodiment of the present invention;

FIG. 12 is a diagram illustrating an exemplary first security pattern input screen output from an AVN display according to an exemplary embodiment of the present invention;

FIG. 13 is a diagram illustrating an exemplary navigation screen displayed on an AVN display according to an exemplary embodiment of the present invention;

FIG. 14 is a diagram illustrating an exemplary audio screen displayed on an AVN display according to an exemplary embodiment of the present invention;

FIG. 15 is a diagram illustrating an exemplary DMB screen displayed on an AVN display according to an exemplary embodiment of the present invention;

FIG. 16 is an exemplary control block diagram of a vehicle according to another exemplary embodiment of the present invention;

FIG. 17 is an exemplary control flowchart of a vehicle according to another exemplary embodiment of the present invention; and

FIG. 18 is an exemplary control flowchart of a vehicle according to still another exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Purposes, specific advantages, and novel features of the invention will be apparent from exemplary embodiments and the following detailed descriptions in connection with the accompanying drawings. In this specification, when reference numerals are assigned to components of each drawing, it should be noted that, when the same components are illustrated in different drawings, the same numerals are assigned to the same components whenever possible. In descriptions of the invention, when detailed descriptions of related well-known technology are deemed to unnecessarily obscure the gist of the invention, they will be omitted. In this specification, although the terms first, second, etc. are used to distinguish one component from another, these components are not limited by these terms.

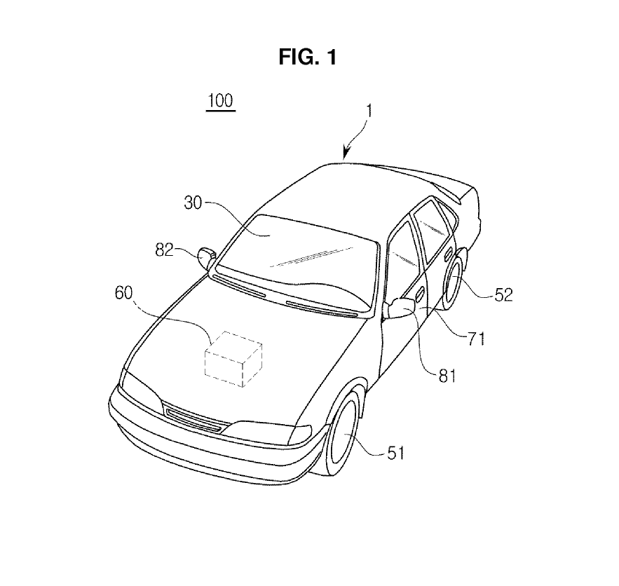

Hereinafter, a vehicle 100 and a method of controlling the vehicle 100 will be described with reference to FIGS. 1 to 18. FIG. 1 illustrates an exterior of a vehicle according to an exemplary embodiment of the present invention seen from the exterior.

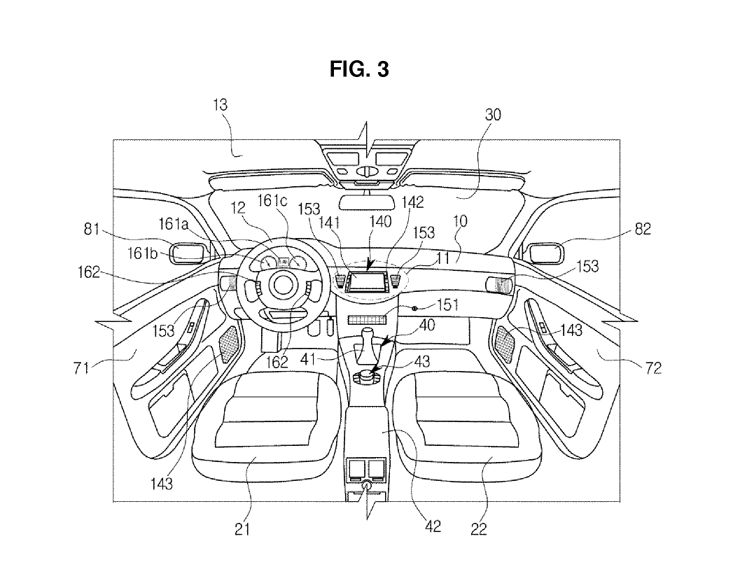

As illustrated in FIG. 1, the vehicle 100 according to the exemplary embodiment of the present invention may include a main body 1 forming an exterior of the vehicle 100, wheels 51 and 52 moving the vehicle 100, a driving device 60 rotating the wheels 51 and 52, doors 71 and 72 (refer to FIG. 3) shielding an inside of the vehicle 100 from the exterior, a front glass 30 that provides a field of view in front of the vehicle 100 to a user within the vehicle 100, and side mirrors 81 and 82 that provide a field of view behind the vehicle 100 to the user.

The wheels 51 and 52 include the front wheels 51 disposed in the front of the vehicle and the rear wheels 52 disposed in the rear of the vehicle. The driving device 60 provides rotary power to the front wheels 51 or the rear wheels 52 to move the main body 1 forward or backward. The driving device 60 may include an engine configured to combust fossil fuels and generate rotary power or a motor configured to receive power from a condenser (not illustrated) and generate rotary power.

The doors 71 and 72 may be disposed pivotally on left and right sides of the main body 1. When the doors are opened, the user may enter the vehicle 100 and when the doors are closed, the doors shield the inside of the vehicle 100 from the exterior. The front glass 30 is provided in the upper front of the main body 1 and enables the user in the vehicle 100 to obtain visual information from in front of the vehicle 100, and is also called a windshield glass. In addition, the side mirrors 81 and 82 include the left side mirror 81 disposed on the left side of the main body 1 and the right side mirror 82 disposed on the right side thereof. These allow the user in the vehicle 100 to obtain visual information from beside (e.g., on the side of the vehicle) and behind the vehicle 100.

The vehicle 100 may further include a detecting device such as a proximity sensor configured to detect a rear or side obstacle or other vehicles, or a rain sensor configured to detect rainfall and precipitation. The proximity sensor may be configured to transmit a detection signal to a side or a rear of the vehicle, and receive a reflection signal reflected from an obstacle such as another vehicle. Based on a waveform of the received reflection signal, the obstacle at the side or rear of the vehicle 100 may be detected and a location of the obstacle may be detected. As an example of such a proximity sensor, a method in which an ultrasound is transmitted and a distance to an obstacle is detected using an ultrasound reflected from the obstacle may be used.

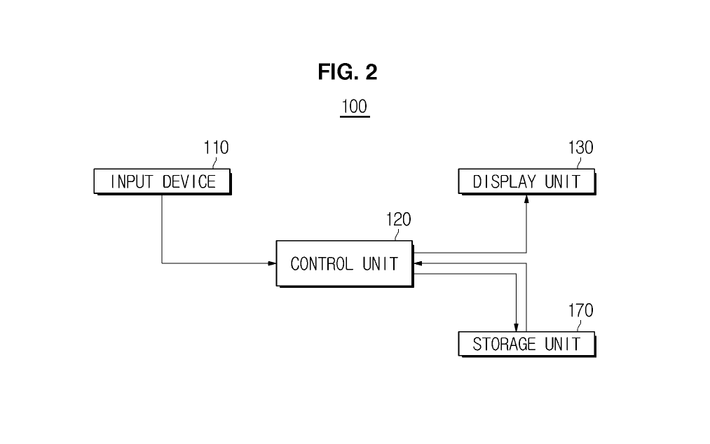

FIG. 2 is an exemplary control block diagram of a vehicle according to an exemplary embodiment. As illustrated in FIG. 2, the vehicle 100 may include an input device 110 configured to receive a manipulation from a user, a controller 120 configured to determine whether a security pattern input by the manipulation matches a security pattern previously stored in the vehicle 100 and generate a control signal corresponding thereto, a display unit 130 configured to display matching of the security pattern and the like to the user, and a storage unit 170 in which the security pattern is stored. In the exemplary embodiment, the user may be a driver or a passenger within the vehicle 100.

The security pattern refers to a combination of commands according to the manipulation received on the input device 110. In other words, the security pattern may be a combination of commands for the input device 110 necessary to identify whether a user has actual authentication (e.g., has access permission) when the user authentication (e.g., a login process) is performed to use an internal system of the vehicle 100. The input device 110 may be a hard key type within the vehicle 100 and may be provided as various types such as a jog shuttle type within the vehicle 100, and may receive the user's command.

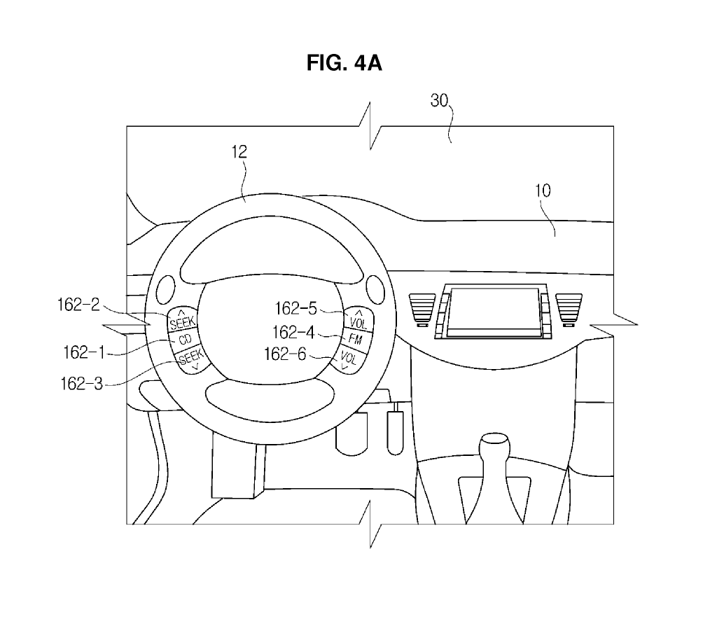

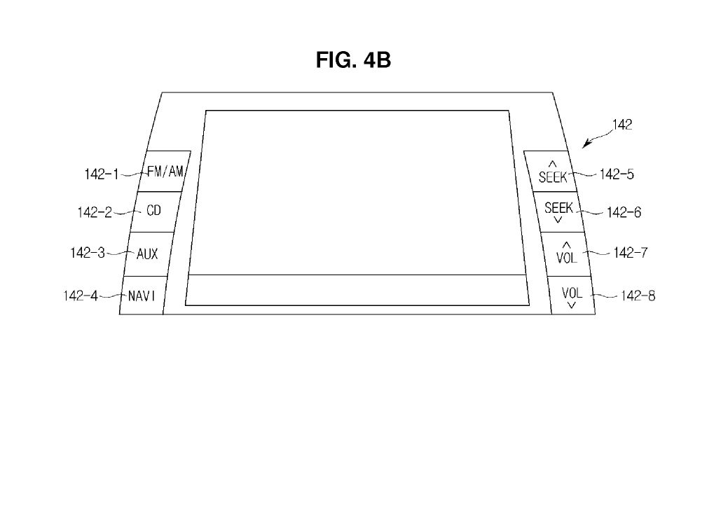

The user may manipulate the input device 110 and input a command for operating an AVN device 140 (refer to FIG. 3) or the vehicle 100. Hereinafter, a location of the input device 110 configured to receive the user's command will be described. FIG. 3 is a diagram illustrating an internal configuration of a vehicle according to an exemplary embodiment. FIGS. 4A-4B, 5, and 6 are diagrams illustrating an exterior of an input device according to various exemplary embodiments.

As illustrated in FIGS. 3 and 4A, the input device 110 may be disposed in a dashboard 10 in the front of the vehicle 100 to receive the user command. Hereinafter, as an example of the input device 110, an AVN input unit 142 will be described. In a center fascia 11 that is a center area of the dashboard 10, an audio video navigation (AVN) display 141 and the AVN input unit 142 may be disposed. The AVN device 140 may be configured to integrally perform an audio function, a video function and a navigation function. The AVN display 141 may be configured to selectively display at least one of an audio screen, a video screen and a navigation screen, and may be implemented as a liquid crystal display (LCD), a light emitting diode (LED), a plasma display panel (PDP), an organic light emitting diode (OLED), a cathode ray tube (CRT) or the like.

The user may manipulate the AVN input unit 142 and input a command for operating the AVN device 140. As illustrated in FIG. 3, the AVN input unit 142 may also be provided as a hard key type in an area adjacent to the AVN display 141. A speaker 143 configured to output a sound may be disposed within the vehicle 100. A sound necessary for performing the audio function, the video function and the navigation function may be output through the speaker 143.

A steering wheel 12 may be disposed in the dashboard 10 at the side of (e.g., protruding towards or facing) a driver seat 21. In an area adjacent to an area in which the steering wheel 12 is disposed within an area of the dashboard 10, a speedometer 161b configured to display a current speed of the vehicle 100 and a revolutions per minute (RPM) gauge 161c configured to display RPM of the vehicle 100 may be provided. In addition, a cluster display 161a configured to display information regarding the vehicle 100 on a digital screen may be further provided.

In particular, the input device 110 may also be disposed in the steering wheel 12 to receive the user manipulation or command. Hereinafter, as an example of the input device 110, a cluster input unit 162 will be described. The cluster input unit 162 may be disposed in the steering wheel 12 and may be configured to receive a selection of information to be displayed on the cluster display 161a from the user. Additionally, since the user may manipulate the cluster input unit 162 while driving, a selection of information to be displayed on the cluster display 161a and a command for operating the AVN device 140 may be received.

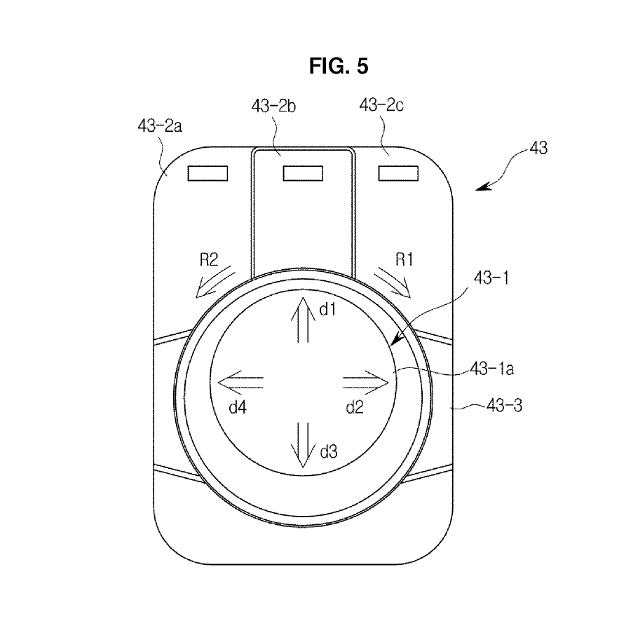

Meanwhile, as illustrated in FIGS. 3 and 5, the input device 110 may also be disposed in a center console 40 to receive the user manipulation or command. Hereinafter, as an example of the input device 110, a center input unit 43 will be described. The center input unit 43 of a jog shuttle type or a hard key type may be disposed in the center console 40. The center console 40 refers to a part that is disposed between the driver seat 21 and a passenger seat 22, and in which a gear control lever 41 and a tray 42 may be formed. The center input unit 43 may be configured to perform all or some functions of the AVN input unit 142 or may perform all or some functions of the cluster input unit 162.

Accordingly, the input device 110 may be implemented as the AVN input unit 142 disposed in the center area of the dashboard 10, the cluster input unit 162 or the center input unit 43, but the input device is not limited thereto, and includes all input devices of a jog shuttle type or a hard key type disposed within the vehicle such as a door button (not illustrated) disposed inside the doors 71 and 72 and closes the doors 71 and 72 or opens the side mirrors 81 and 82.

Hereinafter, referring again to FIGS. 4A-4B, 5, and 6, an exemplary embodiment of the input device 110 will be described in further detail. As illustrated in FIGS. 4A-4B, the cluster input unit 162 according to the exemplary embodiment may be configured to receive a selection of information to be displayed on the cluster display 161a or a command for operating the AVN device 140. For example, as illustrated in FIG. 4A, when the cluster input unit 162 receives a command for operating the AVN device 140, a hard key 162-1 for playing a compact disc (CD) inserted into the AVN device 140, direction keys 162-2 and 162-3 for moving (e.g., moving to a next track or a previous track) a CD track being played, a hard key 162-4 for operating the AVN device 140 such that a radio function is provided, and direction keys 162-5 and 162-6 for operating a sound level may be disposed in the cluster input unit 162. In particular, the user may input the security pattern using a combination of the hard keys 162-1, 162-2, 162-3, 162-4, 162-5 and 162-6 disposed in the cluster input unit 162.

For example, when the user sequentially presses the up key 162-2 for moving a CD track, a hard key 162-4 for operating the AVN device 140 to provide the radio function, the down key 162-6 for adjusting a sound level and the up key 162-2 for moving a CD track, a combination of the hard keys 162-2, 162-4, 162-6 and 162-2 input by the user and a sequence thereof (162-2->162-4->162-6->162-2) may be stored as the security pattern. However, the form of the hard keys of the cluster input unit 162 is not limited to the illustration in FIG. 4A, but may be implemented as various forms for operating the cluster display 161a or the AVN device 140.

In addition, the number of hard keys (e.g., push keys) input as the security pattern is not limited to four, but a variety of numbers thereof may be input. The AVN input unit 142 according to the exemplary embodiment may be configured to receive a command for operating the AVN device 140. For example, as illustrated in FIG. 4B, the AVN input unit 142 may include a hard key 142-1 for operating the AVN device 140 to provide the radio function, a hard key 142-2 for operating a CD, a hard key 142-3 for executing a connection with an external device connected to an AUX terminal (not illustrated), a hard key 142-4 for operating the AVN device 140 to provide the navigation function, direction keys 142-5 and 142-6 for moving a CD track being played, and direction keys 142-7 and 142-8 for adjusting the sound level.

Particularly, the security pattern may be input by a user using the combination of the hard keys 142-1 to 142-8 provided in the cluster input unit 162. For example, when the user sequentially presses the down (e.g., exerts pressure onto) key 142-6 for moving a CD track, the hard key 142-1 for operating the AVN device 140 to provide or enable the radio function, the hard key 142-4 for operating the AVN device 140 to provide or enable the navigation function, and the up key 142-5 for moving a CD track, a combination of the hard keys 142-6, 142-1, 142-4 and 142-5 input by the user and a sequence thereof (142-6->142-1->142-4->142-5) may be stored as the security pattern. However, the form of the hard keys of the AVN input unit 142 is not limited to the illustration in FIG. 4B, but may be implemented as various forms for operating the AVN device 140.

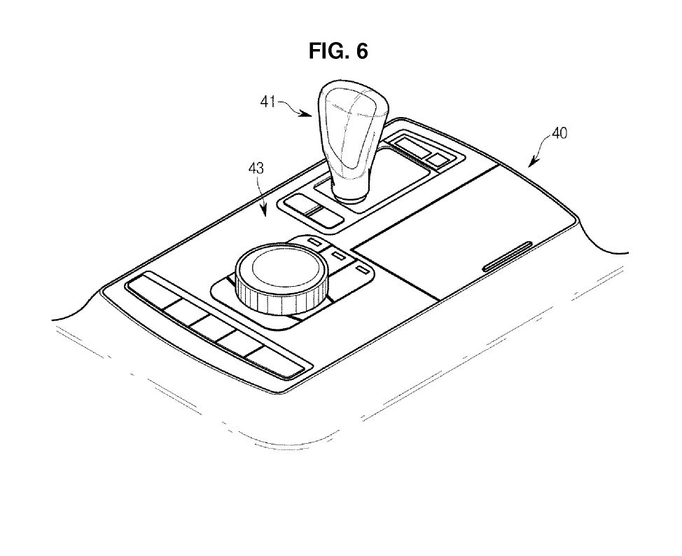

As illustrated in FIGS. 5 and 6, in the exemplary embodiment, the center input unit 43 may be implemented as a jog shuttle. As illustrated in FIG. 5, the center input unit 43 may include a knob part 43-1, hard keys 43-2a to 43-2c and a housing 43-3. At least one knob part 43-1 may include a knob 43-1a rotatable in at least one direction and various components for supporting an operation of the knob 43-1a. The knob 43-1a may rotate in a clockwise direction R1 or a counter-clockwise direction r2 around a predetermined rotation axis. The knob 43-1a may be made of a material such as a metal, a synthetic resin or another composition. A predetermined handgrip (e.g., a preformed handgrip, ergonomic handgrip, or the like) may be formed on an outer surface of the knob 43-1a to provide more comfortable grip to the user. The handgrip may be made of a metal, rubber, a synthetic resin or the like.

Depending on exemplary embodiments, the knob 43-1a may also be inclined in at least one direction d1 to d4 from a central axis. For example, as illustrated in FIG. 5, the knob 43-1a may be inclined in a vertical direction d1 and d3 or a horizontal direction d2 and d4. While the vertical and horizontal directions d1 to d4 are illustrated in FIG. 5 as exemplary directions in which the knob 43-1a may be inclined, directions in which the knob 43-1a may be inclined are not limited thereto, but the knob 43-1a may be inclined in various directions such as an upper left direction (between d1 and d2) or a lower left direction (between d2 and d3). The user may rotate the knob 43-1a or tilt the knob 43-1a in a specific direction to input a predetermined instruction or command.

The hard keys 43-2a to 43-2c may be configured to receive a predetermined instruction or command from the user based on the pressure exerted onto the key. As illustrated in FIG. 5, the hard keys 43-2a to 43-2c may be installed within the housing 43-3. The hard keys 43-2a to 43-2c may be formed in the vicinity of the knob 43-1a (e.g., may be formed adjacent to, in front of, or behind the knob). Different functions to be executed may be assigned to each of the hard keys 43-2a to 43-2c. For example, among the plurality of hard keys 43-2a to 43-2c, the first hard key 43-2a may be a hard key for inputting a CD playing command, the second hard key 43-2b may be a hard key for inputting a navigation function providing command, and the third hard key 43-2c may be a hard key for inputting execution commands for various other applications of the AVN device 140. The various buttons of the hard keys 43-2a to 43-2c may be manipulated by a user to operate various devices in the vehicle. When pressure is exerted on each hard key 115a to 115c, a predetermined electrical signal may be output and transmitted to the controller 120.

Depending on exemplary embodiments, the hard key may be formed in the knob 43-1a. In one exemplary embodiment, the hard key may be formed in an upper surface of the knob 43-1a. Alternatively, the knob 43-1a itself may also perform a function of the hard key. For example, the knob 43-1a may be designed to be movable in a direction of the housing 43-3 or a direction opposite to the direction of the housing 43-3. In particular, the user may press and move the knob 43-1a in the direction of the housing 43-3 and input a predetermined instruction or command similar to the hard key.

The security pattern may be input using a combination of the hard keys 43-2a to 43-2c, a combination of manipulation directions of the knob 43-1a, or a combination of the hard keys 43-2a to 43-2c and manipulation directions of the knob 43-1a. For example, when the knob 43-1a is tilted in the upward direction d1, the center hard key 43-2b is engaged (e.g., pressure is exerted onto the key), the knob 43-1a is rotated in the clockwise direction R1, and then the hard key 43-2b is engaged again, a combination (d1, 43-2b, R1 and 43-2b) of the hard keys 43-2a to 43-2c input by the user and manipulation directions of the knob 43-1a, and a sequence thereof (d1->43-2b->R1->43-2b) may be stored as the security pattern.

The housing 43-3 may support the knob 43-1a of the knob part 43-1, or various components related to an operation of the knob 43-1a may be embedded therein. Within the housing 43-3, a rotation axis member with which the knob 43-1a is combined to be rotatable around a predetermined rotation axis, various members enabling the knob 43-1a to be inclined in a specific direction, and various components related thereto may be installed. Additionally, at least one of various semiconductor chips, switches, integrated circuits, resistors, printed circuit boards (PCBs) and the like may be embedded within the housing 43-3.

At least one semiconductor chip, switch, integrated circuit, resistor or the like may be installed in the printed circuit board inside the housing 43-3. At least one semiconductor chip may be configured to perform information processing or store data. Further, at least one semiconductor chip may be configured to analyze a movement of the knob 43-1a or a predetermined electrical signal generated according to manipulation of a button formed in the knob 43-1a, generate a predetermined control signal according to the analyzed content, and then deliver the signal to the controller 120, the AVN display 141 or the like. Depending on exemplary embodiments, the controller 120 illustrated in FIG. 2 may also be implemented as at least one semiconductor chip embedded within the housing 43-3. In addition, as illustrated in FIG. 6, the input device 110 implemented as a jog shuttle according to the exemplary embodiment may be disposed in the center console 40. However, according to another exemplary embodiment, the AVN input unit 142 disposed in the dashboard 10 or the cluster input unit 162 disposed in the steering wheel 12 may also be implemented as a jog shuttle.

The input device 110 implemented as the hard key or the jog shuttle has been described above. However, the input device 110 is not limited to the above-described hard key or jog shuttle, but may include various mechanical input units configured to manipulate the cluster display 161a or the AVN display 141. The various mechanical input units may include, for example, a trackball, a manipulation device of various stick forms, and various buttons. The various input units described above may be disposed in various positions within the vehicle other than the steering wheel 12, the dashboard 10, and the center console 40.

Referring again to FIG. 2, the controller 120 may be configured to operate each component of the vehicle 100 according to the command received from the input device 110. The controller 120 according to the exemplary embodiment may be configured to store the security pattern that corresponds to a command input by the user in the storage unit 170, or determine whether the security pattern corresponding to the command input by the user is the same as the security pattern stored in the storage unit 170.

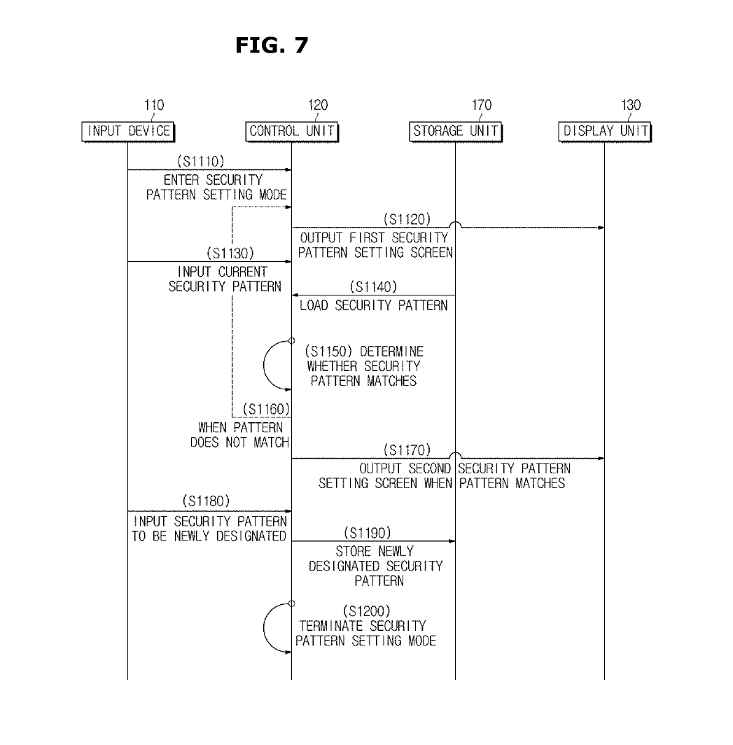

Hereinafter, a control process of the vehicle 100 of the controller 120 in which the security pattern input by the user is stored in the storage unit 170 according to the exemplary embodiment will be described with reference to FIG. 7. FIG. 7 is a control flowchart of a vehicle according to an exemplary embodiment.

As illustrated in FIG. 7, when the process enters a security pattern setting mode (S1110), the controller 120 may be configured to operate the display unit 130 to output a first security pattern setting screen (S1120). The security pattern setting mode refers to a control process in which a new security pattern may be generated and stored in the storage unit 170. The controller 120 may be configured to manually enter the security pattern setting mode according to the user manipulation, but the present invention is not limited thereto. When a preset condition is satisfied, the controller 120 may be configured to automatically enter the security pattern setting mode.

Manually entering the security pattern setting mode according to the user manipulation may include, for example, the user pressing a separate hard key (not illustrated) disposed in the AVN input unit 142, the cluster input unit 162, or the center input unit 43 or pressing any hard key that is provided in advance for about 2 seconds or more. In addition, manually entering the security pattern setting mode according to the user manipulation may include, for example, the user touching a specific tab on the AVN display 141 implemented as a touch pad.

Similar to the input device 110, the display unit 130 may be disposed in the center area of the dashboard 10 to selectively display at least one of an audio screen, a video screen and a navigation screen to the user. The display unit 130 disposed in the center area of the dashboard 10 is referred to as the AVN display 141. Additionally, the display unit 130 may be disposed on the dashboard 10 at the driver seat 21 side to display information regarding the vehicle 100 on a digital screen. The display unit 130 disposed on the dashboard 10 at the driver seat 21 side is referred to as the cluster display 161a.

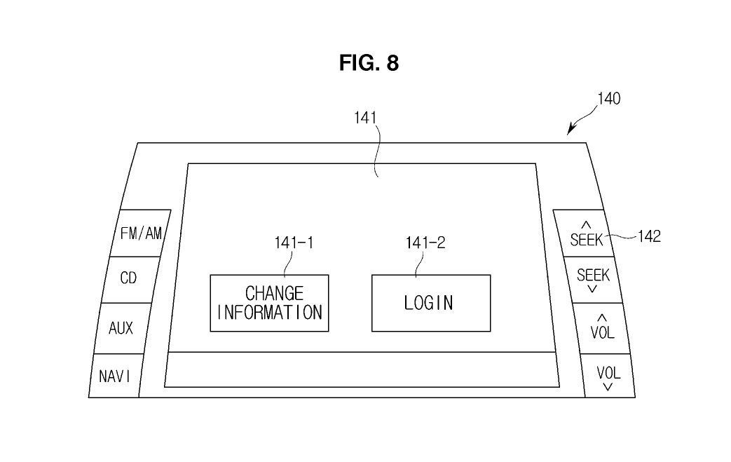

Hereinafter, a screen displayed on the AVN display 141 will be exemplified. FIG. 8 is a diagram illustrating an exemplary screen displayed on an AVN display before the process enters a security pattern setting mode. As illustrated in FIG. 8, the user may touch a specific tab 141-1 on the AVN display 141 implemented as a touch pad (e.g., pressure may be exerted on the touch pad) and enter the security pattern setting mode. The specific tab 141-1 displayed on the AVN display 141 may include, for example, a character string of “change information.”

Meanwhile, the above case of entering the security pattern setting mode is only an example, and may also be changed to various forms. The first security pattern setting screen is a screen for performing user authentication regarding whether the user has a right, that is, permission, to generate a new security pattern before the new security pattern is stored in the storage unit 170, and prompts the user to input the same security pattern as the security pattern stored in advance in the storage unit 170.

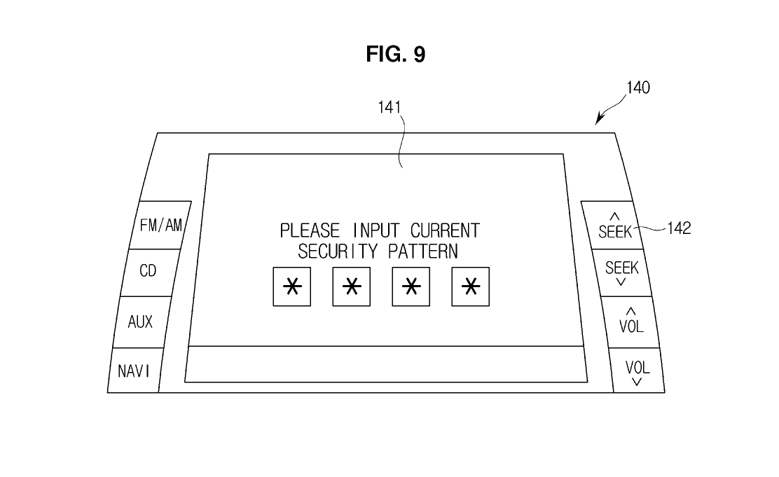

FIG. 9 is a diagram illustrating an exemplary first security pattern setting screen output from an AVN display. As illustrated in FIG. 9, the AVN display 141 may be configured to output a character string (e.g., “please input the current security pattern”) to prompt an input of the same security pattern as the security pattern currently stored in the storage unit 170 on the first security pattern setting screen. However, the present invention is not limited to the outputting of the character string as illustrated in FIG. 9, but a sound for prompting an input of the security pattern may also be output through the speaker 143.

Referring again to FIG. 7, the security pattern may be input by the user through the input device 110 and the security pattern input to the input device 110 may be delivered to the controller 120 (S1130). Further, the controller 120 may be configured to read or load the security pattern stored in the storage unit 170 (S1140). While FIG. 7 illustrates that the security pattern input to the input device 110 may be delivered to the controller 120 and then the controller 120 may be configured to load the security pattern from the storage unit 170, the controller 120 may be configured to load the security pattern from the storage unit 170 and then the security pattern input to the input device 110 may be delivered to the controller 120.

The controller 120 may then be configured to determine whether the security pattern input to the input device 110 is the same as the security pattern loaded from the storage unit 170 (S1150). For example, when a combination of the upward direction d1 of the knob 43-1a of the center input unit 43, the center hard key 43-2b of the center input unit 43, the clockwise direction R1 of the knob 43-1a of the center input unit 43, and the center hard key 43-2b of the center input unit 43 and a sequence thereof are stored as the security pattern in the storage unit 170, when the user tilts the knob 43-1a on the center input unit 43 in the upward direction d1, presses the center hard key 43-2b, rotates the knob 43-1a in the clockwise direction R1, and then presses the center hard key 43-2b again, the controller 120 may be configured to determine that the same security pattern is input and may be configured to operate the display unit 130 to output a second security pattern setting screen (S1170). However, when the user presses the left hard key 43-2a on the center input unit 43, rotates the knob 43-1a in the counter-clockwise direction r2, presses the center hard key 43-2b again, and then tilts the knob 43-1a in the upward direction d1, that is, when a security pattern of a combination different from the combination of the security pattern stored in the storage unit 170 is input (S1160), the controller 120 may be configured to determine that the different security pattern is input (e.g., an incorrect security pattern) and may be configured to operate the display unit 130 to output the first security pattern setting screen again (S1120). In other words, the user may be prompted to attempt a second entry of the security pattern. The user may only be provided with a limited amount of attempts (e.g., a limited number of incorrect inputs).

Additionally, when the user presses the center hard key 43-2b on the center input unit 43, rotates the knob 43-1a in the clockwise direction R1, presses the center hard key 43-2b again, and then tilts the knob 43-1a in the upward direction d1, that is, when the security pattern is input according to a sequence different from the sequence of the security pattern stored in the storage unit 170 (S1160), the controller 120 may be configured to determine that the different security pattern is input and may be configured to operate the display unit 130 to output the first security pattern setting screen again (S1120).

While FIG. 7 illustrates that the first security pattern setting screen for requesting an input of the security pattern again is output when the security pattern different from the security pattern stored in the storage unit 170 is input, the present invention is not limited thereto. The controller 120 may be configured to terminate the security pattern setting mode or output a screen for prompting termination.

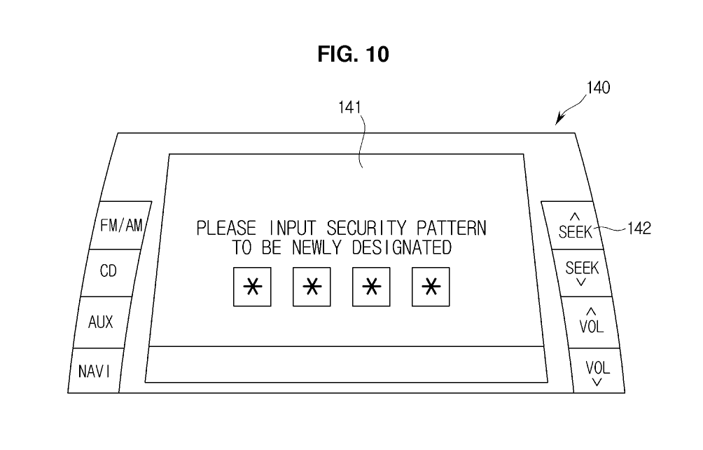

Hereinafter, a control process of the controller 120 when the security pattern input to the input device 110 is the same as the security pattern loaded from the storage unit 170 (S1170) will be described. FIG. 10 is a diagram illustrating an exemplary second security pattern setting screen output from an AVN display.

In response to determining that the same security pattern is input, the controller 120 may be configured to operate the AVN display 141 to output the second security pattern setting screen (S1170). The second security pattern setting screen refers to a screen for prompting the user to input a new security pattern to store the new security pattern in the storage unit 170. For example, as illustrated in FIG. 10, the AVN display 141 may be configured to output a character string (e.g., “please input a security pattern to be newly designated”) for prompting an input of a new security pattern on the second security pattern setting screen.

However, the present invention is not limited to the outputting of the character string as illustrated in FIG. 10, but a sound for prompting an input of the security pattern may also be output through the speaker 143. Referring again to FIG. 7, a security pattern may be input to be newly designated through the input device 110 and then the security pattern input by the user may be delivered to the controller 120 through the input device 110 (S1180). Then, the controller 120 may be configured to store the input security pattern in the storage unit 170 (S1190) and terminate the security pattern setting mode (S1200).

Meanwhile, although not illustrated, the controller 120 may be configured to operate the display unit 130 to output the third security pattern setting screen for prompting the user to re-input a security pattern to be newly designated. In particular, the third security pattern setting screen refers to a screen for prompting the user to re-input the same security pattern as the security pattern input after the second security pattern setting screen is output, and may be configured to output the character string or the sound similar to the second security pattern setting screen.

When the security pattern is received from the user through the input device 110 after the third security pattern setting screen is output, the controller 120 may be configured to determine whether the security pattern received after the second security pattern setting screen is output is the same as the security pattern received after the third security pattern setting screen is output. When the security patterns are the same, the controller 120 may be configured to store the security patterns received after the second and third security pattern setting screens are output in the storage unit 170, and terminate the security pattern setting mode. When the security patterns are not the same, that is, they are different, the controller 120 may be configured to operate the display unit 130 to output the first security pattern again or terminate the security pattern setting mode.

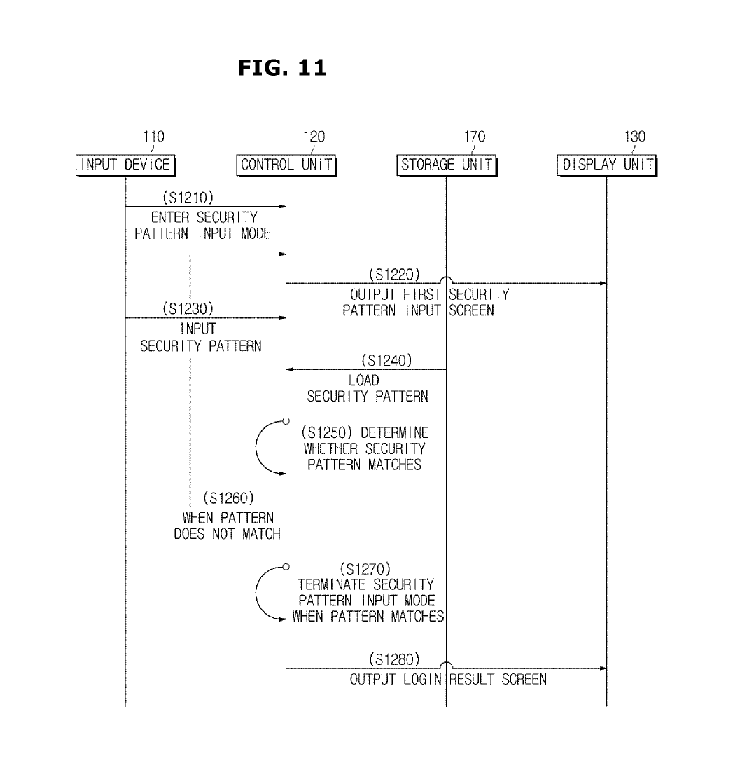

Meanwhile, the controller 120 may be configured to store the security pattern input by the user in the storage unit 170, determine whether the security pattern input by the user is the same as the security pattern stored in the storage unit 170, and perform user authentication. Hereinafter, a control process of the vehicle 100 of the controller 120 in which it is determined whether the security pattern input by the user is the same as the security pattern stored in the storage unit 170 according to another exemplary embodiment will be described with reference to FIG. 11.

FIG. 11 is a control flowchart of a vehicle according to another exemplary embodiment. As illustrated in FIG. 11, when the process enters a security pattern input mode (S1210), the controller 120 may be configured to operate the display unit 130 to output a first security pattern input screen (S1220). The security pattern input mode refers to a control process for determining whether the security pattern input by the user is the same as the security pattern stored in the storage unit 170.

The controller 120 may be configured to manually enter the security pattern input mode according to the user manipulation, but the present invention is not limited thereto. When a preset condition is satisfied, the controller 120 may also be configured to automatically enter the security pattern input mode. Manually entering the security pattern input mode according to the user manipulation may include, for example, the user pressing a separate hard key (not illustrated) disposed in the AVN input unit 142, the cluster input unit 162, or the center input unit 43 or pressing any hard key that is provided in advance for about 2 seconds or more. In addition, referring again to FIG. 8, manually entering the security pattern input mode according to the user manipulation may include, for example, the user touching a specific tab 141-2 on the AVN display 141 implemented as a touch pad. The specific tab 141-2 displayed on the AVN display 141 may include, for example, a character string of “login.”

Meanwhile, the above case of entering the security pattern input mode is merely an example, and may also be changed to various forms. The first security pattern input screen may prompt the user to input the same security pattern as the previously stored security pattern.

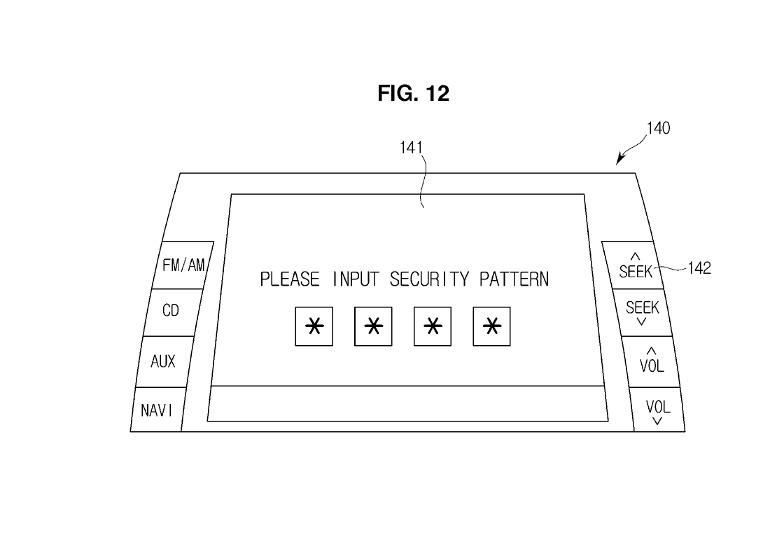

FIG. 12 is a diagram illustrating an exemplary first security pattern input screen output from an AVN display. As illustrated in FIG. 12, the AVN display 141 may be configured to output a character string (e.g., “please input a security pattern”) for prompting an input of the same security pattern as the security pattern currently stored in the storage unit 170 on the first security pattern input screen.

However, the present invention is not limited to the outputting of the character string as illustrated in FIG. 12, but a sound for prompting an input of the security pattern may also be output through the speaker 143. Referring again to FIG. 11, the user inputs the security pattern through the input device 110 and the security pattern input to the input device 110 may be delivered to the controller 120 (S1230). In addition, the controller 120 may be configured to read or load the security pattern stored in the storage unit 170 (S1240).

While FIG. 11 illustrates that the security pattern input to the input device 110 is delivered to the controller 120 and then the controller 120 loads the security pattern from the storage unit 170, the controller 120 may be configured to load the security pattern from the storage unit 170 and then the security pattern input to the input device 110 may be delivered to the controller 120.

Furthermore, the controller 120 may be configured to determine whether the security pattern input to the input device 110 is the same as the security pattern loaded from the storage unit 170 (S1250). For example, when a combination of the upward direction d1 of the knob 43-1a of the center input unit 43, the up hard key 162-2 for moving a CD track of the AVN input unit 142, the clockwise direction R1 of the knob 43-1a of the center input unit 43 and the hard key 142-2 for playing a CD of the cluster input unit 162 and a sequence thereof are stored as the security pattern in the storage unit 170, when the user rotates the knob 43-1a on the center input unit 43 in the upward direction d1, presses the up hard key 162-2 for moving a CD track on the AVN input unit 142, rotates the knob 43-1a on the center input unit 43 in the clockwise direction R1, and presses the hard key 142-2 for playing a CD on the cluster input unit 162, the controller 120 may be configured to determine that the same security pattern is input and terminate the security pattern input mode (S1270), and then operate the display unit 130 to output a login result screen (S1280), indicating a successful authentication. In other words, the login result screen may be an authentication result screen of the user, and may include output screens of various applications that require user authentication in the AVN device 140.

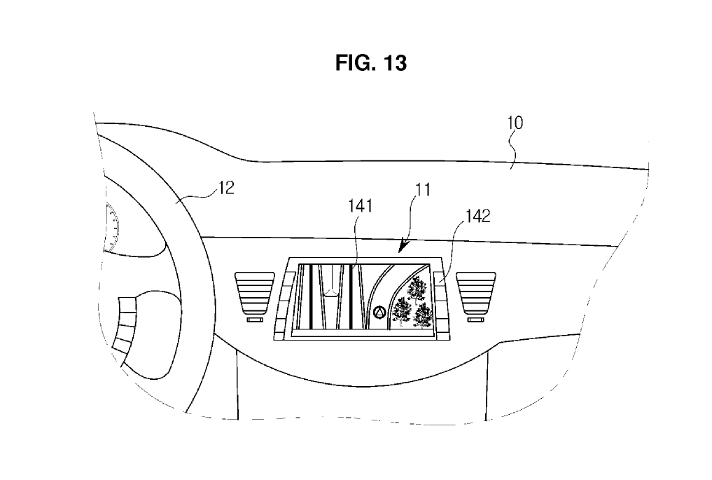

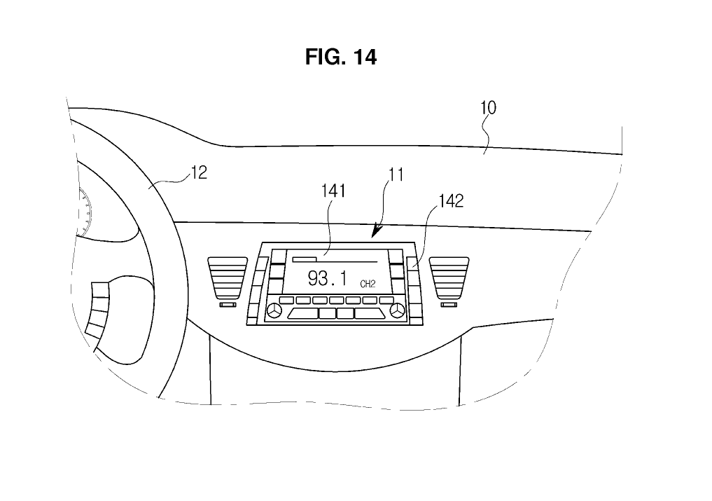

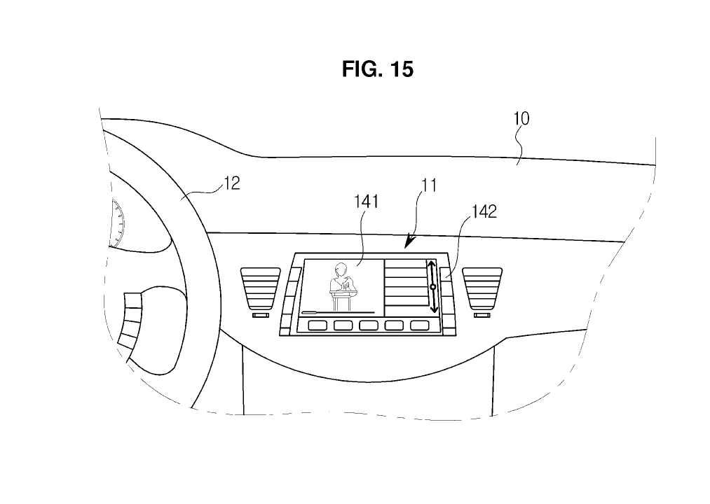

Hereinafter, various output screens of applications in the AVN device 140 will be described with reference to FIGS. 13 to 15. FIG. 13 is a diagram illustrating an exemplary navigation screen displayed on an AVN display. FIG. 14 is a diagram illustrating an exemplary audio screen displayed on an AVN display. FIG. 15 is a diagram illustrating an exemplary DMB screen displayed on an AVN display.

When the user manipulates the AVN input unit 142 and selects a navigation application, the first security pattern input screen may be output on the AVN display 141. When the user is authenticated using the security pattern, the navigation screen may be output on the AVN input unit 142 as illustrated in FIG. 13. When the user manipulates the AVN input unit 142 and selects an audio application, the first security pattern input screen may be output on the AVN display 141. When the user is authenticated using the security pattern, the audio screen may be output on the AVN display 141 as illustrated in FIG. 14, and an audio may output through the speaker 143. When the user manipulates the AVN input unit 142 and selects a video application, the first security pattern input screen may be output on the AVN display 141. When the user is authenticated using the security pattern, a digital multimedia broadcasting (DMB) screen may be displayed on the AVN display 141 as illustrated in FIG. 15. The DMB is an example of the video function. The video function may include a function of reproducing an image recorded on a DVD or a universal serial bus USB) in addition to the DMB.

Moreover, referring again to FIG. 11, when the user inputs the security pattern different from the security pattern stored in the storage unit 170, the controller 120 may be configured to determine that the different security pattern is input and operate the display unit 130 to output the first security pattern setting screen again (S1120). While FIG. 11 illustrates that the first security pattern setting screen for requesting an input of the security pattern again is output when the security pattern different from the security pattern stored in the storage unit 170 is input, the present invention is not limited thereto. The controller 120 may be configured to terminate the security pattern setting mode or output a screen for prompting termination.

Meanwhile, according to another exemplary embodiment, the vehicle 100 may be configured to store the security pattern in the storage unit 170, or transmit the generated security pattern to an external server and perform the above security pattern setting mode and security pattern input mode based on the security pattern transmitted to or received from the server.

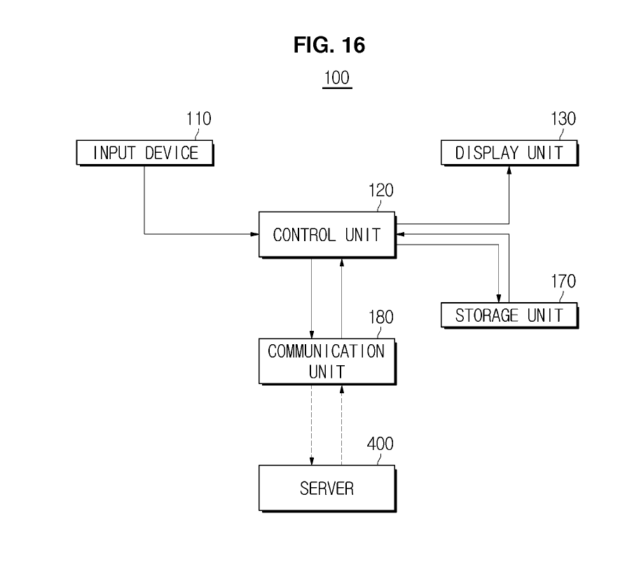

Hereinafter, a method of controlling the vehicle 100 according to another exemplary embodiment will be described with reference to FIGS. 16 to 18. FIG. 16 is a control block diagram of a vehicle according to another exemplary embodiment. As illustrated in FIG. 16, the vehicle 100 may include the input device 110 configured to receive a command according to the user manipulation, the controller 120 configured to determine whether the security pattern input by the user manipulation matches the security pattern stored in the vehicle 100 and generate a control signal corresponding thereto, the display unit 130 configured to display matching of the security pattern and the like to the user, the storage unit 170 in which the security pattern may be stored and a communication unit 180 configured to transmit and receive the security pattern to and from a server 400.

Since the input device 110 has been described above, a redundant description thereof will be omitted. The controller 120 may be configured to transmit the security pattern input by the user to the server 400 via the communication unit 180 or determine whether the security pattern input by the user is the same as the security pattern received from the server 400.

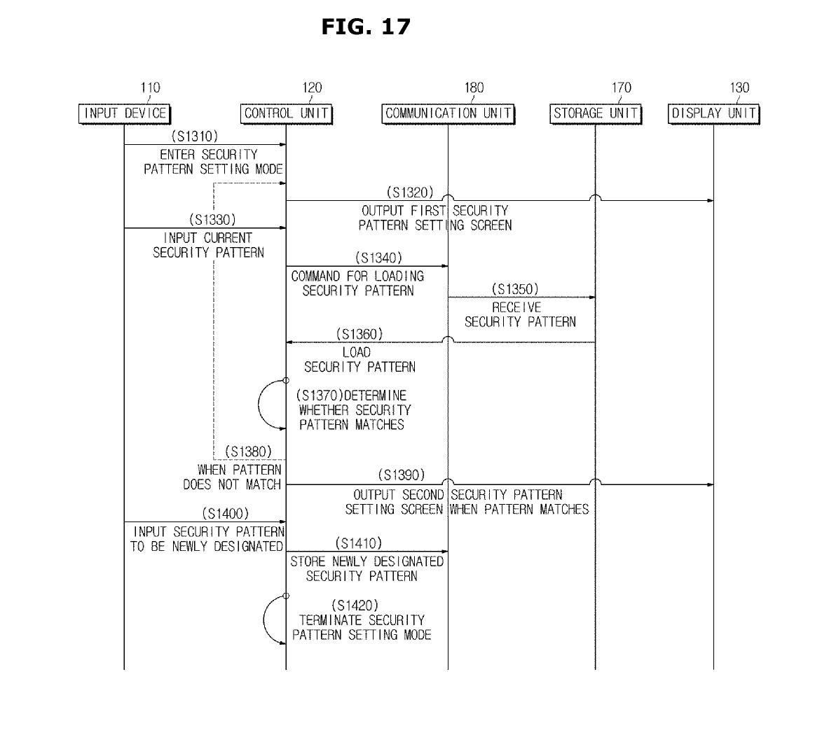

Hereinafter, a control process of the vehicle 100 of the controller 120 in which the security pattern input by the user is transmitted to the server 400 will be described with reference to FIG. 17. FIG. 17 is a control flowchart of a vehicle according to another exemplary embodiment. As illustrated in FIG. 17, when the process enters the security pattern setting mode (S1310), the controller 120 may be configured to operate the display unit 130 to output the first security pattern setting screen (S1320). Since the security pattern setting mode and the first security pattern setting screen have been described above, redundant descriptions thereof will be omitted.

The user inputs the security pattern through the input device 110 and the security pattern input to the input device 110 may be delivered to the controller 120 (S1330). Then, the controller 120 may be configured to operate the communication unit 180 to receive the security pattern stored in the server 400 (S1340). The communication unit 180 may be implemented as a wired and/or wireless communication module and connected to the server 400 via a wired and/or wireless network.

In particular, the wired and/or wireless network may include a wired communication network, a wireless communication network, and a short distance communication network, and may include combinations of the wired communication network, the wireless communication network and the short distance communication network. The wired communication network includes a wired Ethernet, a wide area network (WAN), a value added network (VAN) and a controller area network (CAN). The wireless communication network may access a wireless network at a location in which an access point (AP) (not illustrated) is installed and be connected to the AP. The wireless communication network supports a wireless LAN specification (IEEE802.11x) of IEEE. The short distance communication network includes a Bluetooth communication network, a Bluetooth low energy communication network, an Infrared Data Association (IrDA) communication network, a Wi-Fi communication network, an ultra wideband (UWB), near field communication (NFC), a ZigBee communication network and the like.

Further, the controller 120 may be configured to receive the security pattern from the server 400 via the communication unit 180 and store the received security pattern in the storage unit 170 of the vehicle 100 (S1350). The controller 120 may then be configured to read the security pattern stored in the storage unit 170 (S1360), and determine whether the security pattern input to the input device 110 is the same as the security pattern loaded from the storage unit 170 (S1370).

In response to determining that the same security pattern is input, the controller 120 may be configured to operate the display unit 130 to output the second security pattern setting screen (S1390). When the security pattern different from the security pattern loaded from the storage unit 170 is input (S1380), the controller 120 may be configured to determine that the different security pattern is input, and operate the display unit 130 to output the first security pattern setting screen again (S1320). Since the second security pattern setting screen has been described above, a redundant description thereof will be omitted.

Similar to FIG. 7, while FIG. 17 illustrates that the first security pattern setting screen for requesting an input of the security pattern again is output when the security pattern different from the security pattern loaded from the storage unit 170 is input, the present invention is not limited thereto. The controller 120 may be configured to terminate the security pattern setting mode or output a screen for prompting termination. Hereinafter, a control process of the controller 120 when the security pattern input to the input device 110 is the same as the security pattern loaded from the storage unit 170 (S1390) will be described.

In response to determining that the same security pattern is input, the controller 120 may be configured to operate the AVN display 141 to output the second security pattern setting screen (S1390). The user may input a security pattern to be newly designated through the input device 110, and the security pattern input by the user may be delivered to the controller 120 through the input device 110 (S1400). Then, the controller 120 may be configured to transmit the input security pattern to the server 400 via the communication unit 180 (S1410) and terminate the security pattern setting mode (S1420). Meanwhile, the controller 120 may be configured to transmit the security pattern input by the user to the server 400 and determine whether the security pattern input by the user is the same as the security pattern stored in the server 400.

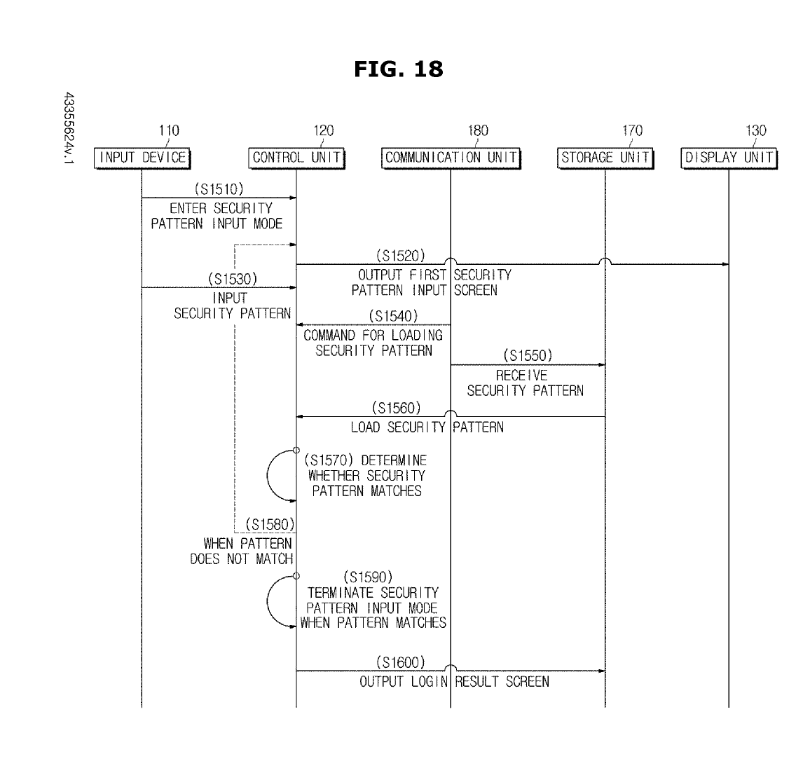

Hereinafter, a control process of the vehicle 100 of the controller 120 in which it is determined whether the security pattern input by the user is the same as the security pattern received from the server 400 according to still another exemplary embodiment will be described with reference to FIG. 18. FIG. 18 is a control flowchart of a vehicle according to still another exemplary embodiment.

As illustrated in FIG. 18, when the process enters the security pattern input mode (S1510), the controller 120 may be configured to operate the display unit 130 to output the first security pattern input screen (S1520). Since the security pattern input mode and the first security pattern input screen have been described above, redundant descriptions thereof will be omitted. When the user inputs the security pattern through the input device 110, the security pattern input to the input device 110 may be delivered to the controller 120 (S1530). In addition, the controller 120 may be configured to operate the communication unit 180 to receive the security pattern stored in the server 400 (S1540).

Further, the controller 120 may be configured to receive the security pattern from the server 400 via the communication unit 180 and store the received security pattern in the storage unit 170 of the vehicle 100 (S1550). The controller 120 may then be configured to read the security pattern stored in the storage unit 170 (S1560) and determine whether the security pattern input to the input device 110 is the same as the security pattern loaded from the storage unit 170 (S1570). In response to determining that the same security pattern is input, the controller 120 may be configured to terminate the security pattern input mode (S1590) and operate the display unit 130 to output the login result screen (S1600). Since the login result screen has been described above, a redundant description thereof will be omitted. Meanwhile, when the security pattern different from the security pattern loaded from the storage unit 170 is input (S1580), the controller 120 performs control such that the display unit 130 outputs the first security pattern input screen again (S1520).

The controller 120 may include a processor, a ROM in which a control program for controlling the vehicle 100 is stored, and a RAM in which a signal or data input from the outside of the vehicle 100 is stored or that is used as a storage area that corresponds to various tasks performed in the vehicle 100. Also, a graphic processing board (not illustrated) including a processor, a RAM or a ROM may be included in a separate circuit board that is electrically connected to the controller 120. The processor, the RAM and the ROM may be connected to each other via an internal bus. The controller 120 may refer to a component that includes the processor, the RAM and the ROM. The controller 120 may also refer to a component that includes the processor, the RAM, the ROM and the processing board.

Meanwhile, while FIGS. 2 and 16 illustrate that the controller 120 includes the ROM in which the control program is stored and the RAM used as a storage area that corresponds to various tasks of the vehicle 100, the storage unit 170 may also include the RAM and the ROM. In addition, the storage unit 170 may be implemented as a component separate from the controller 120, but may be implemented within the controller 120 to include the RAM and the ROM. In particular, the storage unit 170 may be implemented to be coupled to other components of the controller 120 on any one substrate or in the device.

In the above embodiment, some components of the vehicle 100 may be implemented as a type of “module.” Here, the term “module” refers to software or a hardware component such as a field programmable gate array (FPGA) or an application specific integrated circuit (ASIC), and the module performs certain functions. However, the module is not limited to software or hardware. The module may be configured to be included in a storage medium that can be addressed or may be configured to execute at least one processor.

Therefore, examples of the module may include software components, object-oriented software components, class components, components such as task components, processes, functions, properties, procedures, subroutines, segments in program codes, drivers, firmware, microcode, circuits, data, databases, data structures, tables, arrays, and variables. Components and functions provided from modules may be combined into a smaller number of components and modules or may be further separated into additional components and modules. In addition, the components and modules may execute at least one CPU in a device.

Meanwhile, the above method of controlling a vehicle may be implemented as a computer readable code in a computer readable recording medium. The computer readable recording medium includes any type of recording medium in which data that can be interpreted by a computer system is stored. A read only memory (ROM), a random access memory (RAM), a magnetic tape, a magnetic disk, a flash memory, an optical data storage device and the like may be exemplified. Also, the computer readable recording medium may be distributed in computer systems that are connected via a computer communication network and may be stored and executed as a code that can be read in a distributed manner.

The above description is merely exemplary, and it will be understood by those skilled in the art that the invention may be performed in other concrete forms without changing the technological scope and essential features. Therefore, the above-described embodiments should be considered as only examples in all aspects and not for purposes of limitation. For example, each component described as a single type may be realized in a distributed manner, and similarly, components that are described as being distributed may be realized in a coupled manner.

According to the disclosed exemplary embodiments, when the user manipulates the input device, the vehicle and the method of controlling a vehicle may generate a security pattern necessary for user authentication. In addition, according to the vehicle and the method of controlling a vehicle of the disclosed exemplary embodiments, user authentication may be performed by comparing the pre-stored security pattern and a combination of commands input by the user.

The scope of the present invention is defined not by the detailed description but by the appended claims, and encompasses all modifications or alternations derived from meanings, the scope and equivalents of the appended claims.

What is claimed is:

1. A vehicle, comprising:
an input device implemented as at least any of one or more hard keys and a jog shuttle that rotates or is inclined in at least one direction within the vehicle and is configured to receive a command based on an input manipulation;
a storage unit configured to store a combination of commands for the input device as a security pattern; and
a controller configured to perform user authentication based on whether a combination of commands input from the input device matches a security pattern previously stored in the storage unit.

2. The vehicle according to claim 1, wherein the input device is disposed in any one of the group selected from a dashboard, a steering wheel, a center fascia, and a door.

3. The vehicle according to claim 1,
wherein the storage unit is configured to store the combination of commands and a sequence thereof as a security pattern, and
the controller is configured to perform user authentication based on whether the input combination of commands input and the sequence thereof match the previously stored security pattern.

4. The vehicle according to claim 1, further comprising
a display unit configured to display a screen for prompting manipulation of the input device.

5. The vehicle according to claim 1, further comprising:
an audio video navigation (AVN) device in which at least one application is installed; and
a display unit configured to display an output screen of the application installed in the AVN device when the combination of commands input from the input device matches the security pattern previously stored in the storage unit.

6. The vehicle according to claim 1,
wherein, when the input device receives a predetermined command based on the manipulation, the controller is configured to store a command according to the next manipulation as the security pattern in the storage unit.

7. A vehicle, comprising:
an input device implemented as at least any of one or more hard keys and a jog shuttle that rotates or is inclined in at least one direction within the vehicle and is configured to receive a command based on a manipulation;
a communication unit configured to receive a combination of commands for the input device from a server as a security pattern; and
a controller configured to perform user authentication based on whether the input combination of commands matches the security pattern received from the communication unit.

8. The vehicle according to claim 7, further comprising:
a storage unit configured to store the security pattern received by the communication unit,
wherein the controller is configured to read a security pattern stored in the storage unit and perform user authentication based on whether the input combination of commands matches the security pattern stored in the storage unit.

9. The vehicle according to claim 7, wherein the input device is disposed in at least one selected from the group consisting of a dashboard, a steering wheel, a center fascia, and the door.

10. The vehicle according to claim 7, further comprising
a display unit configured to display a screen for prompting manipulation of the input device.

11. The vehicle according to claim 7, further comprising:
an audio video navigation (AVN) device in which at least one application is installed; and
a display unit configured to display an output screen of the application installed in the AVN device when the input combination of commands matches the security pattern received from the server.

12. The vehicle according to claim 7,
wherein, when the input device receives a predetermined command according to the manipulation, the communication unit is configured to transmit a command according to the next manipulation to the server as the security pattern.

13. A method of controlling a vehicle, comprising:
receiving, by a controller, a command based on a manipulation via an input device implemented as at least any of one or more hard keys and a jog shuttle that rotates or is inclined in at least one direction within the vehicle;
reading, by the controller, a combination of commands for the input device that is previously stored in a storage unit;
determining, by the controller, whether a combination of commands input from the input device matches the previously stored combination of commands; and
performing, by the controller, authentication based on whether the input combination of commands input matches the previously stored combination of commands.

14. The method according to claim 13, wherein the performing of the authentication includes:
outputting, by the controller, a user authentication result screen when the input combination of commands matches the previously stored combination of commands.

15. The method according to claim 13, wherein the performing of the authentication includes:
outputting, by the controller, a screen for prompting manipulation of the input device when the input combination of commands is different from the previously stored combination of commands.

16. The method according to claim 13, further comprising:
receiving, by the controller, a command for setting a security pattern via the input device; and
storing, by the controller, the input security pattern for setting the security pattern in the storage unit.

17. The method according to claim 16, wherein the receiving of the command for setting a security pattern includes:
receiving, by the controller, a predetermined command based on the manipulation; and
receiving, by the controller, a command based on the next manipulation as the security pattern.

18. The method according to claim 13, further comprising:
before the reading of the combination of commands, receiving, by the controller, a combination of commands for the input device previously stored in a server; and
storing, by the controller, the received combination of commands in the storage unit.

19. The method according to claim 13, wherein the determining of whether the combination matches includes:
determining, by the controller, whether the input combination of commands and a sequence thereof match the previously stored combination of commands and a sequence thereof.

20. The method according to claim 13, further comprising:
before the receiving of the command according to the manipulation, displaying, by the controller, a screen for prompting the manipulation the input device.

21. A non-transitory computer readable medium containing program instructions executed by a controller, the computer readable medium comprising:
program instructions that receive a command based on a manipulation via an input device implemented as at least any of one or more hard keys and a jog shuttle that rotates or is inclined in at least one direction within the vehicle;
program instructions that read a combination of commands for the input device that is previously stored in a storage unit;
program instructions that determine whether a combination of commands input from the input device matches the previously stored combination of commands; and
program instructions that perform authentication based on whether the input combination of commands input matches the previously stored combination of commands.

22. The non-transitory computer readable medium of claim 21, further comprising:
program instructions that output a user authentication result screen when the input combination of commands matches the previously stored combination of commands.

23. The non-transitory computer readable medium of claim 21, further comprising:
program instructions that output a screen for prompting manipulation of the input device when the input combination of commands is different from the previously stored combination of commands.
